(19) United States
(12) Patent Application Publication
(10) Pub. No.: US 2017/0104808 A1
(43) Pub. Date: Apr. 13, 2017

(54) NETWORK APPLIANCE, FEATURE PHONE, NETWORK APPLIANCE, SYSTEM AND CONTROL METHOD OF NETWORK APPLIANCE

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: ZHEN LI, TIANJIN (CN)

(21) Appl. No.: 15/255,265

(22) Filed: Sep. 2, 2016

Related U.S. Application Data
(63) Continuation of application No. PCT/CN2016/087872, filed on Jun. 30, 2016.

(30) Foreign Application Priority Data
Oct. 8, 2015 (CN) 201510644385.X

(51) Int. Cl. H04L 29/08; G06F 17/30; G06K 19/06; H04L 12/28

(52) U.S. Cl. CPC H04L 67/025; H04L 67/141; H04L 12/2818; G06F 17/30879; G06K 19/06028

(57) ABSTRACT

A control method of a network appliance, a network appliance, a mobile terminal and system, are provided. The control method includes: acquiring, by a feature phone, a control webpage address of the network appliance; opening, by the feature phone, a control webpage corresponding to the control webpage address through a browser, wherein the control webpage includes a control element and an address of the network appliance; and sending, by the feature phone, control request information corresponding to the control element to the network appliance through an internet by using the address of the network appliance as a destination address, when detecting that the control element is triggered.

### CROSS-REFERENCES TO RELATED APPLICATIONS

This application is a continuation application to PCT/CN2016/087872, having a filing date of Jun. 30, 2016, which is based upon and claims priority to Chinese Patent Application No. 201510644385.X, having a filing date of Oct. 8, 2015, the entire contents of which are incorporated herein by reference.

### FIELD OF TECHNOLOGY

The following relates to the technical field of network appliance control, for example, relates to a network appliance, a feature phone, a network appliance, system and a control method of network application.

### BACKGROUND

As network appliance technologies have been gradually getting mature, network appliances represented by smart televisions have more and more function, resulting in a brand-new use experience for a user.

The network appliance may be generally equipped with a remote controller, so that the user may conveniently control various functions of the network appliance by using the remote controller. However, the remote controller is generally a physical key type remote controller which is tedious in an operating process, and requires periodic replacement of a battery. When there are multiple network appliances at home, a plurality of corresponding remote controllers are easily confused.

### SUMMARY

An aspect relates to a control method of a network appliance, a mobile terminal, a network appliance and system so as to realize that a non-smart feature phone controls the network appliance.

In one aspect, an embodiment of the present disclosure provides a control method of a network appliance, including:

acquiring, by a mobile terminal, a control webpage address of the network appliance;
opening, by the mobile terminal, a control webpage corresponding to the control webpage address through a browser, wherein
the control webpage comprises a control element and an address of the network appliance; and
sending, by the mobile terminal, control request information corresponding to the control element to the network appliance through an internet by using the address of the network appliance as a destination address, when detecting that the control element is triggered.

In a second aspect, an embodiment of the present disclosure provides a control method of a network appliance, including:

providing, by the network appliance, a control webpage address, wherein the control webpage address corresponds to a control webpage, the control webpage comprises control element and an address of the network appliance;
receiving, by the network appliance, control request information corresponding to the control element, wherein the control request information is sent through an Internet by using the address of the network appliance as a destination address, when the control element are detected to be triggered; and
executing, by the network appliance, corresponding operations according to the control request information.

In a third aspect, an embodiment of the present disclosure provides a mobile terminal, including:

at least one processor; and
a memory communicably connected with the at least one processor for storing instructions executable by the at least one processor, wherein execution of the instructions by the at least one processor causes the at least one processor to: acquire a control webpage address of a network appliance;
open a control webpage corresponding to the control webpage address through a browser, wherein the control webpage comprises a control element and an address of the network appliance; and
send control request information corresponding to the control element to the network appliance through the Internet, by using the address of the network appliance as a destination address, when detecting that the control element is triggered.

In a fourth aspect, an embodiment of the present disclosure provides a network appliance, including:

at least one processor; and
a memory communicably connected with the at least one processor for storing instructions executable by the at least one processor, wherein execution of the instructions by the at least one processor causes the at least one processor to:
provide a control webpage address, wherein
the control webpage address corresponds to a control webpage, the control webpage comprises an control element and an address of the network appliance;
receive control request information corresponding to the control element, wherein the control request information is sent through the internet by using the address of the network appliance as a destination address, when the control element is detected to be triggered; and
execute corresponding operations according to the control request information.

In a fifth aspect, an embodiment of the present disclosure provides a network appliance system, including a mobile terminal and a network appliance, wherein a mobile terminal, comprising: at least one processor; and

a memory communicably connected with the at least one processor for storing instructions executable by the at least one processor, wherein execution of the instructions by the at least one processor causes the at least one processor to: acquire a control webpage address of a network appliance;
open a control webpage corresponding to the control webpage address through a browser, wherein the control webpage comprises a control element and an address of the network appliance; and
send control request information corresponding to the control element to the network appliance through the Internet, by using the address of the network appliance as a destination address, when detecting that the control element is triggered, and the network disclosure, comprising: at least one processor; and a memory communicably connected with the at least one processor for storing instructions executable by the at least one processor, wherein execution of the instructions by the at least one processor causes the at least one processor to:
provide a control webpage address, wherein the control webpage address corresponds to a control webpage, the control webpage comprises an control element and an address of the network appliance;
receive control request information corresponding to the control element, wherein the control request information is sent through the internet by using the address of the network appliance as a destination address, when the control element is detected to be triggered; and execute corresponding operations according to the control request information.

In a sixth aspect, an embodiment of the present disclosure provides a nonvolatile computer storage medium, which stores a computer executable instruction, wherein the computer executable instruction is used to perform a control method of a network appliance at a mobile terminal side according to any one of embodiments of the present disclosure.

In a seventh aspect, an embodiment of the present disclosure provides a nonvolatile computer storage medium, which stores a computer executable instruction, wherein the computer executable instruction is used to execute a control method of a network appliance at a network appliance side according to any one of embodiments of the present disclosure.

### BRIEF DESCRIPTION

Some of the embodiments will be described in detail, with reference to the following figures, wherein like designations denote like members, wherein:

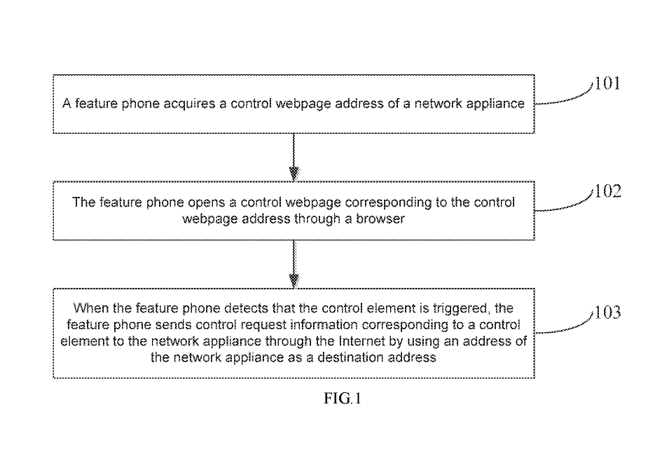

FIG. 1 is a schematic flowchart showing a control method of a network appliance according to some embodiments of the present disclosure;

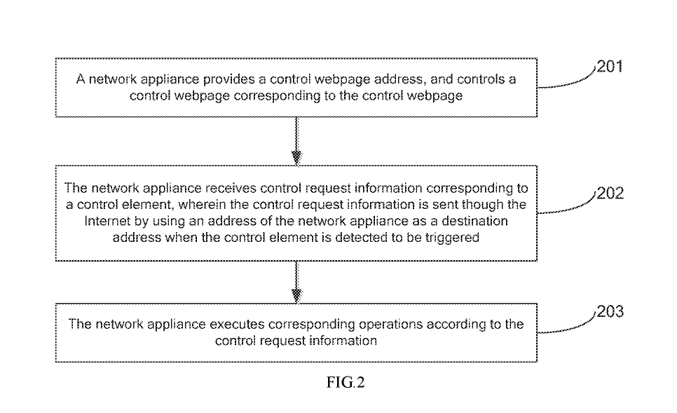

FIG. 2 is a schematic flowchart showing a control method of a network appliance according to some embodiments of the present disclosure;

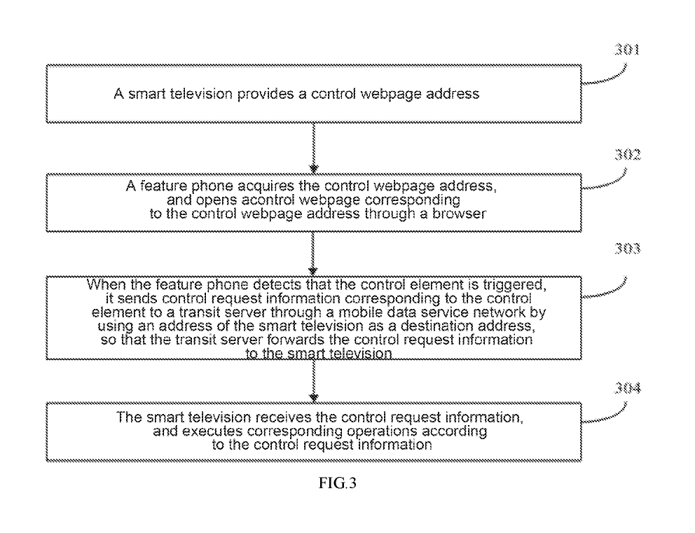

FIG. 3 is a schematic flowchart showing a control method of a smart television according to some embodiments of the present disclosure;

FIG. 4 is a block diagram showing a structure showing a feature phone according to some embodiments of the present disclosure;

FIG. 5 is a block diagram showing a structure showing a network appliance according to some embodiments of the present disclosure;

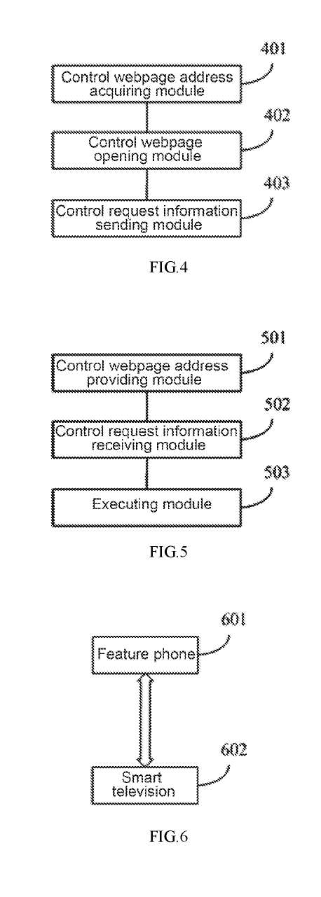

FIG. 6 is a block diagram showing a structure of a network appliance system according to some embodiments of the present disclosure;

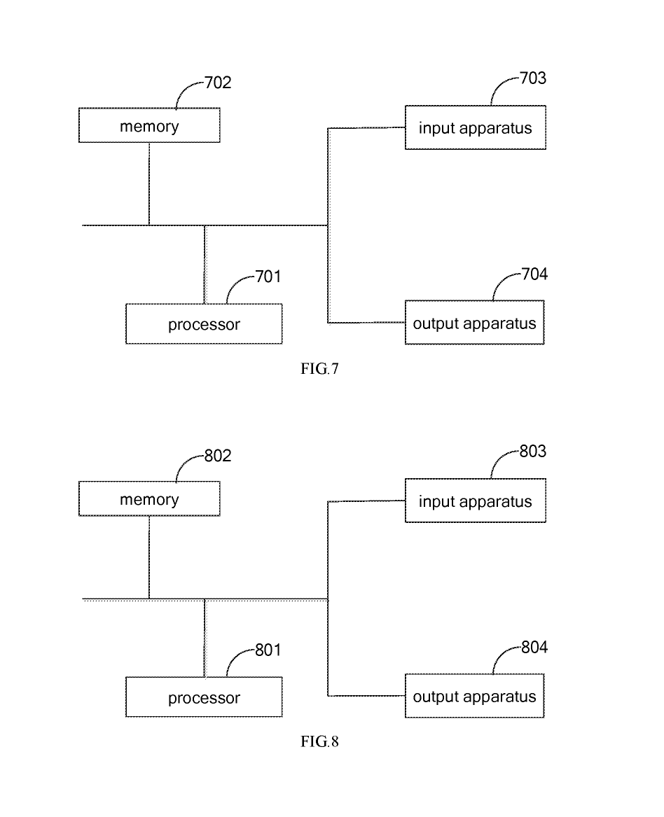

FIG. 7 is a schematic diagram showing a hardware structure of a feature phone according to some embodiments of the present disclosure; and

FIG. 8 is a schematic diagram showing a hardware structure of a network appliance according to some embodiments of the present disclosure.

### DETAILED DESCRIPTION

Technical solutions of the present disclosure will be described below in conjunction with the accompanying drawings and embodiments. It should be understood that the embodiments described herein are merely used to explain the present disclosure, and are not intended to limit the present disclosure. In addition, for easy of description, only parts relevant to the present disclosure rather than all structures are shown in the accompanying drawings.

Furthermore, before discussing exemplary embodiments in more detail, some exemplary embodiments will be described as a process or method depicted by a flow diagram. Although the flow diagram describes steps as a sequential process, many of operations may be implemented in parallel, concurrently or simultaneously. In addition, the order of the steps may be re-arranged. The process may be terminated when corresponding steps are completed, but may also have additional steps which are not included in the accompanying drawings. The process may correspond to a method, a function, a procedure, a sub-routine, a sub-program and the like.

In related arts, in order to solve disadvantages of a traditional network appliance remote controller, one solution is as follows: a remote controller application is installed on a smart phone commonly used by a user, the user realizes controlling on the network appliance by using this application. However, compared with a non-smart feature phone, when using the smart phone, although the user may install the application to realize a variety of functions, the smart phone also has some disadvantages, such as short standby time, relatively large weight, complicated operation, easily encountered reset or dead halt, and moreover, children could be addicted to games or videos due to their relatively poor possessiveness once using the smart phone. Accordingly, partial users, especially, the middle-aged and elderly users and children, mostly use the feature phone.

However, the feature phone may not install the remote controller application, so that the user can not realize control on the network appliance through the feature phone.

### Embodiment 1

FIG. 1 is a schematic flowchart showing a control method of a network appliance according to some embodiments of the present disclosure. This method may be performed by a mobile terminal, for example feature phone, and may be realized by software and/or hardware configured in the feature phone. As shown in FIG. 1, the method includes:

In step 101, the feature phone acquires a control webpage address of a network appliance.

Compared to a smart phone, the feature phone is a non-smart phone, generally without an independent operating system and with functions which have been fixed in a design stage, so that the feature phone cannot execute a native program, has less portions available for being configured and extended by a user, and typically only supports an application extension based on a Java platform.

The network appliance, such as a smart television, a network refrigerator, a network washing machine and a network air conditioner, in this embodiment may be an appliance with a networking function. Exemplarily, after accessing to a network (for example accessing to a local area network by connecting a router in a home), the network appliance may be automatically assigned an Internet Protocol (IP) address, which may be referred to as an address of the network appliance; a webpage address (hereinafter referred to as the control webpage address) used for controlling the network appliance may be determined according to the IP address; and a control webpage may be opened in a browser according to the control webpage address. For example, the IP address assigned to the network appliance is 172.0.0.1, and the control webpage address may be determined to be http://172.0.0.1/index.html according to the IP address.

Exemplarily, that the feature phone acquires the control webpage address of the network appliance may have several manners: the feature phone scans a 2-dimensional bar code, which is provided by the network appliance, based on a Java platform, and extracts the control webpage address, which is included in the 2-dimensional bar code, of the network appliance; or the feature phone receives a control webpage address, which is input in the browser by a user, of the network appliance; or the feature phone calls the control webpage address, which is pre-stored in the browser, of the network appliance. For example, when the feature phone supports a Java extending function, a 2-dimensional bar code scanning software based on the Java platform, such as the 2-dimensional code scanning software based on a JavaME (Java Platform, Micro Edition), may be built in a system of the feature phone or be installed in the feature phone by the user, the user may use the software to scan the 2-dimensional bar code provided by the network appliance, and extracts the control webpage address, which is included in the 2-dimensional bar code, of the network appliance. For another example, the feature phone generally has the browser, the user may directly open the browser in the feature phone, and inputs the control webpage address displayed on the network appliance into an address bar of the browser; or, when the network appliance is always in a same local area network, the IP address assigned to the network appliance may not change, and the corresponding control webpage address of the network application may not change as well, thus the user may store the control webpage address in a favorite of the browser for a first-time use, and may directly find and call the control webpage address in the favorite or a browsing history record for a next-time use.

In step 102, the feature phone opens a control webpage corresponding to the control webpage address through the browser.

The control webpage may include control elements and the address of the network appliance.

Exemplarily, the control elements may be virtual control buttons generated based on a Javascrip technology. For example, the virtual control buttons in the control webpage may be generated by a Google Webpage Toolkit (GWT) which provides common controls (such as buttons and the like) and may customize the buttons, so that a relatively visual interface of the remote controller may be made, and operations of the user on the control webpage are facilitated, wherein the virtual control button may include various buttons included in a traditional remote controller, such as volume add-subtract buttons, channel switch buttons, a main menu button, a return button and directional buttons (left, right, up and down) in a smart television remote controller; also such as air speed adjusting buttons, temperature adjusting buttons and mode buttons in a network air conditioner remote controller. Exemplarily, the control elements and other page content information, which are included in the control webpage, may be pre-stored in the network appliance, and may be acquired or dynamically updated by the network appliance through a web-enabled function; and finally the control webpage is generated according to the address of the network appliance and the page content information. The feature phone may open the control webpage corresponding to the control webpage address through the browser.

In step 103, when detecting that the control element is triggered, the feature phone sends control request information corresponding to the control element to the network appliance through the Internet by using the address of the network appliance as a destination address.

Exemplarily, when the user selects a control element from the control webpage opened in the feature phone through the browser, that is, the control element is triggered. The feature phone can send the control request information corresponding to the control element to the network appliance through the Internet by using the address of the network appliance, which is included in the control webpage, as the destination address.

Optionally, when the feature phone detects that the control element is triggered, the feature phone may generate the control request information based on the Hyper Text Transfer Protocol (HTTP) corresponding to the control elements, and sends the control request information to the network appliance through the Internet, by using the address of the network appliance as the destination address of the control request information. Correspondingly, a HTTP server may be provided in the network appliance, and may be application software which may establish a HTTP connection and analyze a HTTP, or may be application software which may be based on a common network television platform system, such as an Android system or Linux system.

Exemplarily, a few number of feature phones may have a Wireless Fidelity (WIFI) function, such feature phones with the WIFI function may connect a domestic local area network through WIFI, and may transmit the control request information through the domestic local area network. However, a large number of feature phones have no WIFI function, so as not to connect the domestic local area network, for such feature phones without the WIFI function, the control request information corresponding to the control elements can be sent to a transit server through a mobile data service network, by using the address of the network appliance as the destination address, so that the transit server forwards the control request information to the network appliance. Exemplarily, the transit server may be a server of a network operator, and may also be a server customized by a network appliance merchant.

According to the control method of the network appliance in the embodiment 1 of the present disclosure, the user may acquire the control webpage address of the network appliance by using the feature phone, and opens the corresponding control webpage through the browser; and when the user triggers the control elements in the control webpage, the feature phone sends the control request information corresponding to the control elements to the network appliance through the Internet by using the address of the network appliance as the destination address, so that the network appliance executes corresponding operations according to the control request information. By employing the above technical solutions, the user may easily realize control on the network appliance by using the non-smart phone, a demand of controlling the network appliance by using the non-smart phone is satisfied, and the user experience is improved.

### Embodiment 2

FIG. 2 is a schematic flowchart showing a control method of a network appliance according to some embodiments of the present disclosure. The method may be performed by the network appliance, and may be realized by software and/or hardware configured in the network appliance. As shown in FIG. 2, the method includes:

In step 201, the network appliance provides the control webpage address, wherein the control webpage address corresponds to the control webpage.

The control webpage includes control elements and the address of the network appliance.

Exemplarily, that the network appliance provides the control webpage address may have several manners as follow: the network appliance determines the control webpage address according to an IP address of the network appliance, generates a 2-dimensional bar code according to the control webpage address of the network appliance and displays the 2-dimensional bar code; or, the network appliance determines the control webpage address according to the IP address of the network appliance, and displays the control webpage address. The 2-dimensional bar code is black and white graphics formed by distributing a certain specific geometric figure in a plane (in a two-dimensional direction) according to a certain rule for recording data symbol information. In this embodiment, the network appliance may employ an open source 2-dimensional bar code to generate a code, and generates a 2-dimensional bar code according to the control webpage address. And the network appliance may display the 2-dimensional bar code or the control webpage address on a display screen of the network appliance, wherein a suitable time for displaying the 2-dimensional bar code or the control webpage address may be set by system defaults or may be controlled by the user. For example, the network appliance may automatically display the 2-dimensional bar code or the control webpage address at boot according to system settings, or may automatically hide the 2-dimensional bar code or control the webpage address when detecting that the user accesses the control webpage or has sent the control request information; the user may also call the 2-dimensional bar code or the control webpage address out by triggering a physical button on the network appliance or operating an original physical remote controller.

In step 202, the network appliance receives the control request information corresponding to the control elements, wherein the control request information is sent through the Internet by using the address of the network appliance as the destination address, when the control elements are detected to be triggered.

Exemplarily, a large number of feature phones have no WIFI function, so as not to connect the domestic local area network, and the network appliance receives the control request information corresponding to the control element, wherein the control request information is sent to the transit server through a mobile data service network and forwarded by the transit server, when the feature phone detects that the control elements are triggered.

In step 203, the network appliance executes corresponding operations according to the control request information.

Exemplarily, the control request information may be the control request information based on HTTP. This step may include: the network appliance analyzes the control request information based on the HTTP and obtains control request data, acquires a control instruction corresponding to the control request data, and controls the network appliance to execute corresponding operations according to the control instruction.

Exemplarily, the network appliance may include a HTTP server, and the HTTP server may be application software which may establish the HTTP connection and analyze the HTTP, or may be application software which may be based on a common network television platform system, such as an Android system. The HTTP server can analyze the HTTP-based control request information and obtains the control request data, an analysis process may include Header analysis and Body analysis, wherein the Body analysis is divided into PUT analysis and Post analysis according to a request method. Exemplarily, the control instruction and a correspondence between the control instruction and the control request data may be pre-stored in the network appliance, wherein the control instruction may include a command name and a command content, for example, the command name may include control commands, such as volume adjustment or channel switch, and may further include push commands, such as network resource acquisition; the command content may include up, down, left, right and so on.

According to the control method of the network appliance, which is provided by the embodiment 2 of the present disclosure, the network appliance provides the control webpage address, so that the feature phone opens the corresponding control webpage through the browser, and executes corresponding operations when receiving the control request information sent through the Internet. By employing the above technical solution, the user may be allowed to easily realize control on the network appliance by using a non-smart phone, the demand of the user of the non-smart phone for controlling the network appliance by using the non-smart phone is satisfied, and the user's experience is improved.

### Embodiment 3

FIG. 3 is a schematic flowchart showing a control method of a smart television according to some embodiments of the present disclosure. The method may be executed by cooperating the feature phone with a smart television. Exemplarily, it will be illustrated by taking the feature phone and a smart television as an example, and the method may be implemented by software and/or hardware. As shown in FIG. 3, the method includes:

In step 301, the smart television provides the control webpage address.

Exemplarily, after the user opens the smart television, the smart television may determine the control webpage address according to the IP address of the smart television, and displays the control webpage address on a television screen.

In step 302, the feature phone acquires the control webpage address, and opens the control webpage corresponding to the control webpage address through the browser.

Exemplarily, the user may manually input the control webpage address displayed on the television screen of the smart television into the address bar of the browser of the feature phone, and opens the control webpage in a display screen of the feature phone, wherein the control webpage includes a virtual control button generated based on a Javascrip technology and an address of the smart television. The user can see control buttons corresponding to a traditional remote controller. In addition, each control button also has corresponding text information, and the user may learn about a function of each control button from the text information displayed on the control button.

In step 303, when the feature phone detects the control elements are triggered, the feature phone sends the control request information corresponding to the control elements to the transit server through the mobile data service network (such as a 3G network) by using the address of the smart television as the destination address, so that the transit server forwards the control request information to the smart television.

Exemplarily, the user may realize operations such as selection and the like on the virtual control button in the control webpage by pressing the physical key of the feature phone, so that the feature phone can send the control request information to the smart television according to the operations of the user.

In step 304, the smart television receives the control request information, and executes corresponding operations according to the control request information.

Exemplarily, the control request information may be HTTP-based control request information. The HTTP server in the smart television receives the control request information forwarded by the transit server, and analyzes and acquires a control instruction, so that the smart television executes corresponding operations according to the control instruction, wherein the corresponding operations may be channel switch, sound adjustment and the like.

According to the control method of the smart television, which is provided by this embodiment 3, the user may be allowed to easily realize control on the smart television by using a non-smart phone, the demand of controlling the network appliance by using the non-smart phone is satisfied, and the user's experience is improved.

### Embodiment 4

FIG. 4 is a block diagram showing a structure of a feature phone according to some embodiments of the present disclosure. As shown in FIG. 4, the feature phone includes a control webpage address acquiring module 401, a control webpage opening module 402 and a control request information sending module 403.

The control webpage address acquiring module 401 is configured to acquire the control webpage address of the network appliance; the control webpage opening module 402 is configured to open the control webpage corresponding to the control webpage address through the browser, wherein the control webpage includes control elements and the address of the network appliance; and the control request information sending module 403 is configured to send control request information corresponding to the control elements to the network appliance through the Internet, by using the address of the network appliance as the destination address, when detecting that the control elements are triggered.

Compared to a smart phone, the feature phone is a non-smart phone, generally without an independent operating system and with functions which have been fixed in a design stage, so that the feature phone cannot execute a native program, has less portions available for being configured and extended by a user, and typically only supports an application extension based on a Java platform. Exemplarily, in this embodiment, the control webpage address acquiring module in the feature phone may be configured to scan a 2-dimensional bar code provided by the network appliance based on a Java platform, and extract the control webpage address, which is included in the 2-dimensional bar code, of the network appliance; or receive the control webpage address, which is input in the browser by the user, of the network appliance; or call the control webpage address, which is pre-stored in the browser, of the network appliance.

After the feature phone acquires the control webpage address, the control webpage opening module opens the control webpage corresponding to the control webpage address through the browser on the feature phone, wherein the control webpage includes control elements and an address of the network appliance. Optionally, the control elements may be virtual control buttons generated based on a Javascrip technology. The virtual control buttons may include a variety of buttons which are included in a traditional remote controller, and the control webpage presents a visual remote controller interface to the user so as to facilitate the operation of the user.

Optionally, the control request information sending module may include a control request information generating sub-module and a control request information sending sub-module, wherein the control request information generating sub-module is configured to generate Hyper Text Transport Protocol (HTTP)-based control request information corresponding to the control elements, when detecting that the control elements are triggered; the control request information sending submodule is configured to send the generated HTTP-based control request information to the network appliance through the Internet, by using the address of the network appliance as a destination address of the control request information.

When the user uses the feature phone provided by the embodiment 4 of the present disclosure, the user may acquire the control webpage address provided on the network appliance, and opens the control webpage in the browser. Control on the network appliance is easily realized through operations of selection and the like on the control elements in the control webpage, the demand of the user of the non-smart phone for controlling the network appliance by using the phone is satisfied, and the user's experience is improved.

### Embodiment 5

FIG. 5 is a block diagram showing a structure of a network appliance according to some embodiments of the present disclosure. As shown in FIG. 5, the network appliance includes a control webpage address providing module 501, a control request information receiving module 502 and an executing module 503.

The control webpage address providing module 501 is configured to provide a control webpage address, wherein the control webpage address corresponds to a control webpage, the control webpage includes control elements and an address of the network appliance; the control request information receiving module 502 is configured to receive control request information corresponding to the control elements, wherein the control request information is sent through the Internet by using the address of the network appliance as a destination address, when the control elements are detected to be triggered; and the executing module 503 is configured to execute corresponding operations according to the control request information.

The network appliance, such as a smart television, a network refrigerator, a network washing machine and a network air conditioner, in this embodiment may be an appliance with a networking function. Exemplarily, after the network appliance accesses to a network (for example accessing to a local area network by connecting a router in a home), the network appliance may be automatically assigned the Internet Protocol (IP) address, which may be referred to as the address of the network appliance; the webpage address may be determined as the control webpage address according to the IP address; and the control webpage may be opened in the browser according to the control webpage address. Exemplarily, in this embodiment, the control webpage address providing module in the network appliance may be configured to determine the control webpage address according to the Internet Protocol address of the network appliance, generate a 2-dimensional bar code according to the control webpage address of the network appliance, and display the 2-dimensional bar code; or determine the control webpage address according to the Internet Protocol address of the network appliance, and display the control webpage address.

Alternatively, the control request information may be the control request information based on the HTTP. The executing module may include an analysis sub-module, a control instruction acquiring sub-module and an executing sub-module, wherein the analysis sub-module is configured to analyze the HTTP-based control request information and obtain control request data; the control instruction acquiring submodule is configured to acquire a control instruction corresponding to the control request data; and the executing submodule is configured to control the network appliance to execute corresponding operations according to the control instruction. Exemplarily, the network appliance may include a HTTP server, and the HTTP server may be application software which may establish a HTTP connection and analyze a HTTP, or may be application software which may be based on a common network television platform system, such as an Android system. The HTTP server can analyze the HTTP-based control request information and obtain the control request data. The control instruction and a correspondence between the control instruction and the control request data may be pre-stored in the network appliance, wherein the control instruction may include the command name and the command content, for example, the command name may include control commands, such as volume adjustment or channel switch, and may further include push commands, such as network resource acquisition; the command content may include up, down, left, right and so on.

Exemplarily, when the feature phone used for controlling the network appliance has no WIFI function, so as not to connect a domestic local area network, the control request information receiving module may be configured to receive the control request information corresponding to the control elements, wherein the control request information is sent to the transit server through the mobile data service network and forwarded by the transit server when the control elements are detected to be triggered.

The network appliance provided by Embodiment 5 of the present disclosure may provide the control webpage address, so as to facilitate the user to acquire the control webpage address by using the feature phone and open the control webpage corresponding to the control webpage address. When the user performs operations of selection and the like on the control elements on the control webpage, the network appliance can receive and analyze the control request information sent by the feature phone and execute the corresponding operations, thereby enabling the user to easily realize the control on the network appliance, satisfying the demand of the user of the non-smart feature phone for controlling the network appliance by using the non-smart phone, and improving the user's experience.

### Embodiment 6

Embodiment 6 of the present disclosure provides a network appliance system, including at least a feature phone in embodiments of the present disclosure and at least a network appliance in embodiments of the present disclosure.

Exemplarily, the network appliance system may include a plurality of network appliances, for example, may include a smart television, a network refrigerator, a network washing machine, a network air conditioner and the like. There may be a plurality of network appliances of the same type, such as the smart television in a bedroom, the smart television in a parlor, and the like. The user may open the control webpage corresponding to a certain network appliance by the feature phone to control the network appliance. The network appliance system may include a plurality of feature phones, which allow a plurality of users to respectively control each network appliance.

To illustrate, the embodiment provides a simple network appliance system. FIG. 6 is a block diagram of a structure of a network appliance system according to an embodiment 6 of the present disclosure. As shown in FIG. 6, this network appliance system includes a feature phone 601 and a smart television 602, wherein data transmission is performed between the feature phone 601 and the smart television 602 based on a HTTP, and the user may realize control on the smart television 602 by using the feature phone 601.

### Embodiment 7

Embodiment of the present disclosure provides a non-transitory computer storage medium, including computer executable instructions used to perform the control method of the network appliance at the feature phone side in any of the above method embodiments.

### Embodiment 8

Embodiment of the present disclosure provides a non-transitory computer storage medium including computer executable instructions used to perform the control method of the network appliance at the network appliance side in any of the above method embodiments.

### Embodiment 9

FIG. 7 is a block diagram showing a hardware structure of a mobile terminal according to Embodiment 9 of the present disclosure. As shown in FIG. 7, the feature phone includes:

one or more processors 701 and a memory 702, wherein exemplified in FIG. 7 is one processor 701.

The feature phone may further include an input apparatus 703 and an output apparatus 704.

The processor 701, the memory 702, the input apparatus 703 and the output apparatus 704 in the feature phone may be connected by a bus or by any other means, and exemplified in FIG. 7 is a bus connection.

The memory 702, serving as a non-transitory computer readable storage medium, may be used to store a non-transitory software program, a non-transitory computer executable program and modules, such as program instructions/modules corresponding to the control method of the network appliance in the embodiments of the present disclosure (for example, the control webpage address acquiring module 401, the control webpage opening module 402 and the control request information sending module 403 as shown in FIG. 4). The processor 701 executes various functional applications of a server and data processing by running the non-transitory software program, the instructions and the modules which are stored in the memory 702, that is, the processor can realize the control method of the network appliance at the feature phone side in any of the above method embodiments.

The memory 702 may include a program storage area and a data storage area, wherein the program storage area may store an operating system, and at least one application required by a function; the data storage area may store data created according to the use of the network appliance, and the like. In addition, the memory 702 may include a high-speed random access memory, and may further include a non-transitory memory, for example, at least one magnetic disk memory device, a flash memory device, or other non-transitory solid-state memory devices. In some embodiments, the memory 702 optionally includes memories remotely disposed relative to the processor 701, and these memories remotely disposed may be connected to the network appliance through a network. Instances of the above network include but not limited to Internet, Intranet, a local area network, a mobile communication network and a combination thereof.

The input apparatus 703 may be used to receive input digital or character information, and produce a key signal input related to user settings and function control of the network appliance. The output apparatus 704 may include display devices such as a display screen.

The one or more modules are stored in the memory 702, and execute the control method of the network appliance in any of the above method embodiments when being executed by the one or more processors 701.

### Embodiment 10

FIG. 8 is a block diagram showing a hardware structure of a network appliance according to Embodiment 10 of the present disclosure. As shown in FIG. 8, the network appliance includes:

one or more processors 801 and a memory 802, wherein exemplified in FIG. 7 is one processor 801.

The network appliance may further include an input apparatus 803 and an output apparatus 804

The processor 801, the memory 802, the input apparatus 803 and the output apparatus 804 in the feature phone may be connected by a bus or by any other means, and exemplified in FIG. 8 is a bus connection.

The memory 802, serving as a non-transitory computer readable storage medium, may be used to store a non-transitory software program, a non-transitory computer executable program and modules, such as program instructions/modules corresponding to the control method of the network appliance in the embodiments of the present disclosure (for example, the control webpage address providing module 501, the control request information receiving module 502 and the executing module 503 as shown in FIG. 5). The processor 801 executes various functional applications of a server and data processing by running the non-transitory software program, the instructions and the modules which are stored in the memory 802, that is, the processor can realize the control method of the network appliance in any of the above method embodiments.

The memory 802 may include a program storage area and a data storage area, wherein the program storage area may store an operating system, and at least one application required by a function; the data storage area may store data created according to the use of the network appliance, and the like. In addition, the memory 802 may include a high-speed random access memory, and may further include a non-transitory memory, for example, at least one magnetic disk memory device, a flash memory device, or other non-transitory solid-state memory devices. In some embodiments, the memory 802 optionally includes memories remotely disposed relative to the processor 801, and these memories remotely disposed may be connected to the network appliance through a network. Instances of the above network include but not limited to Internet, Intranet, a local area network, a mobile communication network and a combination thereof.

The input apparatus 803 may be used to receive input digital or character information, and produce a key signal input related to user settings and function control of the network appliance. The output apparatus 804 may include display devices such as a display screen.

The one or more modules are stored in the memory 802, and execute the control method of the network appliance in any of the above method embodiments when being executed by the one or more processors 801.

The above product may execute the method provided by the embodiments of the present disclosure, and has the corresponding functional modules of executing the method and advantageous effects. Technical details which are not exhaustively described in this embodiment may refer to the method provided by the embodiments of the present disclosure.

The electronic equipment in embodiments of this disclosure exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or, in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement does not make essential of corresponding technical solutions depart from spirits and scope of technical solutions of various embodiments.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A control method of a network appliance, comprising:
acquiring, by a mobile terminal, a control webpage address of the network appliance;
opening, by the mobile terminal, a control webpage corresponding to the control webpage address through a browser, wherein the control webpage comprises a control element and an address of the network appliance; and
sending, by the mobile terminal, control request information corresponding to the control element to the network appliance through an internet by using the address of the network appliance as a destination address, when detecting that the control element is triggered.

2. The method according to claim 1, wherein acquiring, by the mobile terminal, the control webpage address of the network appliance comprises:
scanning, by the mobile terminal, a 2-dimensional bar code provided by the network appliance, and extracting the control webpage address, which is included in the 2-dimensional bar code, of the network appliance,
receiving, by the mobile terminal, the control webpage address, which is input in the browser by a user, of the network appliance, or
calling, by the mobile terminal, the control webpage address, which is pre-stored in the browser, of the network appliance.

3. The method according to claim 2, wherein scanning, by the mobile terminal, the 2-dimensional bar code provided by the network appliance comprises:
scanning, by the mobile terminal, the 2-dimensional bar code, which is provided by the network appliance, based on a Java platform application.

4. The method according to claim 1, wherein the control element is a virtual control button.

5. The method according to claim 1, wherein sending, by the mobile terminal, the control request information corresponding to the control element to the network appliance through the internet, by using the address of the network appliance as the destination address, when detecting that the control element is triggered comprises:
generating, by the mobile terminal, the control request information based on a network transport protocol corresponding to the control element, when detecting that the control element is triggered; and
sending, by the mobile terminal, the control request information based on the network transport protocol to the network appliance through the Internet, by using the address of the network appliance as the destination address of the control request information.

6. The method according to claim 5, wherein sending, by the mobile terminal, the control request information based on the network transport protocol to the network appliance through the Internet, by using the address of the network appliance as the destination address of the control request information comprises:
sending, by the mobile terminal, the control request information corresponding to the control element to a transit server through a mobile data service network, by using the address of the network appliance as the destination address, so that the transit server forwards the control request information to the network appliance.

7. A control method of a network appliance, comprising:
providing, by the network appliance, a control webpage address, wherein the control webpage address corresponds to a control webpage, the control webpage comprises a control element and an address of the network appliance;
receiving, by the network appliance, control request information corresponding to the control element, wherein the control request information is sent through an Internet by using the address of the network appliance as a destination address, when the control element is detected to be triggered; and
executing, by the network appliance, corresponding operations according to the control request information.

8. The method according to claim 7, wherein providing, by the network appliance, the control webpage address comprises:
determining, by the network appliance, the control webpage address according to an Internet Protocol address of the network application, generating a 2-dimensional barcode according to the control webpage address of the network appliance, and displaying the 2-dimensional bar code, or
determining, by the network appliance, the control webpage address according to the Internet Protocol address of the network application, and displaying the control webpage address.

9. The method according to claim 7, wherein the control request information is the control request information based on a network transport protocol, and executing, by the network appliance, corresponding operations according to the control request information comprises:
analyzing, by the network appliance, the control request information based on the network transport protocol and obtaining, by the network appliance, control request data;
acquiring, by the network appliance, a control instruction corresponding to the control request data; and
controlling, by the network appliance, the network appliance to execute corresponding operations according to the control instruction.

10. The method according to claim 7, wherein receiving, by the network appliance, control request information corresponding to the control element, wherein the control request information is sent through the Internet by using the address of the network appliance as a destination address, when the control element is detected to be triggered comprises:
receiving, by the network application, the control request information corresponding to the control element, wherein the control request information is sent to a transit server through a mobile data service network and forwarded by the transit server, when the control element is detected to be triggered.

11. A mobile terminal, comprising:
at least one processor; and
a memory communicably connected with the at least one processor for storing instructions executable by the at least one processor, wherein execution of the instructions by the at least one processor causes the at least one processor to:
acquire a control webpage address of a network appliance;
open a control webpage corresponding to the control webpage address through a browser, wherein the control webpage comprises a control element and an address of the network appliance; and
send control request information corresponding to the control element to the network appliance through the Internet, by using the address of the network appliance as a destination address, when detecting that the control element is triggered.

12. The mobile terminal according to claim 11, wherein to acquire the control webpage address of a network appliance, the execution of the instructions by the at least one processor causes the at least one processor to:
scan a 2-dimensional bar code provided by the network appliance, and extract the control webpage address, which is included in the 2-dimensional bar code, of the network appliance,
receive the control webpage address, which is input in the browser by a user, of the network appliance, or
call the control webpage address, which is pre-stored in the browser, of the network appliance

13. The mobile terminal according to claim 12, wherein the step to scan the 2-dimensional bar code provided by the network appliance comprises:
scanning the control webpage address of the network appliance based on a Java platform.

14. The mobile terminal according to claim 11, wherein the control element is a generated virtual control button.

15. The mobile terminal according to claim 11, wherein to send control request information corresponding to the control element to the network appliance through the Internet, the execution of the instructions by the at least one processor causes the at least one processor to:
generate the control request information based on a network transport protocol corresponding to the control element, when detecting that the control element is triggered; and
send the control request information based on the network transport protocol to the network appliance through the Internet, by using the address of the network appliance as a destination address of the control request information.

16. A network appliance, comprising:
at least one processor; and
a memory communicably connected with the at least one processor for storing instructions executable by the at least one processor, wherein execution of the instructions by the at least one processor causes the at least one processor to:
provide a control webpage address, wherein the control webpage address corresponds to a control webpage, the control webpage comprises a control element and an address of the network appliance;
receive control request information corresponding to the control element, wherein the control request information is sent through the internet by using the address of the network appliance as a destination address, when the control element is detected to be triggered; and
execute corresponding operations according to the control request information.

17. The network appliance according to claim 16, wherein the execution of the instructions by the at least one processor causes the at least one processor to:
determine a control webpage address according to an Internet Protocol address of the network appliance, generate a 2-dimensional bar code according to the control webpage of the network appliance, and display the 2-dimensional bar code, or
determine the control webpage address according to the Internet Protocol address of the network application, and display the control webpage address.

18. The network appliance according to claim 16, wherein the control request information is the control request information based on the network transport protocol; to execute corresponding operations according to the control request information, the execution of the instructions by the at least one processor further causes the at least one processor to:
analyze the control request information based on the network transport protocol and obtain control request data;
acquire a control instruction corresponding to the control request data; and
control the network appliance to execute corresponding operations according to the control instruction.

19. The network appliance according to claim 16, wherein to receive control request information corresponding to the control element, the execution of the instructions by the at least one processor further causes the at least one processor to:
receive the control request information corresponding to the control element, wherein the control request information is sent to a transit server through a mobile data service network and forwarded by the transit server, when the control element is detected to be triggered.

20. A non-transitory computer storage medium storing computer-executable instructions for performing the method of claim 1.

21. A non-transitory computer storage medium storing computer-executable instructions for performing the method of claim 7.
